(19) United States
(12) Patent Application Publication
(10) Pub. No.: US 2021/0365421 A1
(43) Pub. Date: Nov. 25, 2021

(54) DATA ANALYSIS METHOD, COMPUTER DEVICE AND STORAGE MEDIUM

(71) Applicant: HON HAI PRECISION INDUSTRY CO., LTD., New Taipei (TW)

(72) Inventor: MENG-CHE YANG, New Taipei (TW)

(21) Appl. No.: 17/021,179

(22) Filed: Sep. 15, 2020

(30) Foreign Application Priority Data
May 20, 2020 (CN) 202010432182.5

(51) Int. Cl. G06F 16/215; G06F 16/2455; G06F 16/27; G06F 16/25

(52) U.S. Cl. CPC G06F 16/215; G06F 16/258; G06F 16/27; G06F 16/24564

(57) ABSTRACT

A data analysis method is provided, the data analysis method obtains to-be-analyzed data, determines whether there is abnormal data in the to-be-analyzed data according to a first preset rule, and searches an operation instruction corresponding to the abnormal data in a first database in response that there is abnormal data in the to-be-analyzed data. The operation instruction is executed, and an execution result of the operation instruction is output, an abnormal cause of the abnormal data is determined according to the execution result. By utilizing the data analysis method, the data analysis is performed more intelligently, quickly and accurately, the efficiency of data analysis can be improved, and the abnormal analyzed data can be classified to store. A data analysis device for applying the method and a computer device applying method are also provided.

### FIELD

Embodiments of the present disclosure relates to technical fields of data analysis, specifically to a data analysis method, a data analysis device, a computer device and a computer storage medium.

### BACKGROUND

In a field of data processing, analyzing and processing data in different formats and different sources are necessary, and contents and a format of the data conforming to predetermined rules are determined. Currently, data analysis methods are inefficient and not smart enough.

### BRIEF DESCRIPTION OF THE DRAWINGS

FIG. 1 is a diagram of an embodiment of an application environment of a data analysis method.

FIG. 2 is a flowchart of an embodiment of the data analysis method.

FIG. 3 is a block diagram of an embodiment of a data analysis device.

FIG. 4 is a block diagram of an embodiment of a computer device.

### DETAILED DESCRIPTION

In order to enable those skilled in the art to better understand the solution of the present disclosure, the technical solutions in the embodiments of the present disclosure will be described below with reference to drawings in the embodiments of the present disclosure. Obviously, described embodiments are merely embodiments which are a part of the present disclosure, rather than every embodiment. All other embodiments obtained by those of ordinary skill in the art based on the embodiments of the present disclosure without creative efforts should be within the scope of the present disclosure.

Terms such as “first”, “second” in the specification and claims of the present disclosure and the above drawings are used to distinguish different objects, and are not intended to describe a specific order. Moreover, terms “include” and any variations of the “include” are intended to indicate a non-exclusive inclusion. For example, a process, a method, a system, a product, or a device which includes a series of steps or units is not limited to listed steps or units, but optionally, also includes steps or units not listed, or optionally, also includes other steps or units inherent to these processes, methods, products, or equipment.

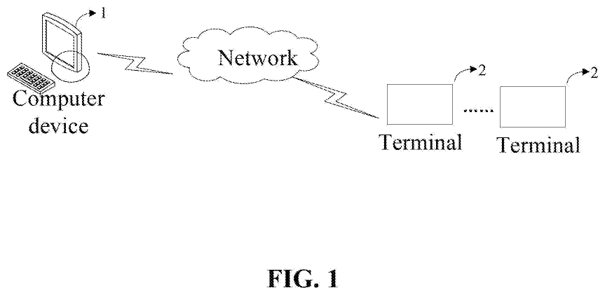

FIG. 1 is a diagram of an embodiment of an application environment of an embodiment of a data analysis method.

In the present disclosure, the data analysis method may be applied to a computer device 1, and the computer device 1 and at least one terminal 2 establish a communication connection through a network. The network may be a wired network or a wireless network, such as, a radio, a wireless fidelity (e.g., Wi-Fi), a cellular, a satellite, and a broadcasting. The terminal 2 is used to send to-be-analyzed data. The computer device 1 is used to receive the to-be-analyzed data, and perform a judgment processing on the to-be-analyzed data according to a first preset rule and stores the processed data in a second database.

The computer device 1 may be a computer device installed with a data analysis software, such as a personal computer, a server, etc., and the server may be a single server, a server cluster, or a cloud server.

The terminal 2 is a computer device having a data collection function, the terminal 2 includes, but is not limited to, a smart phone, a tablet computer, a laptop portable computer, a desktop computer, and the like.

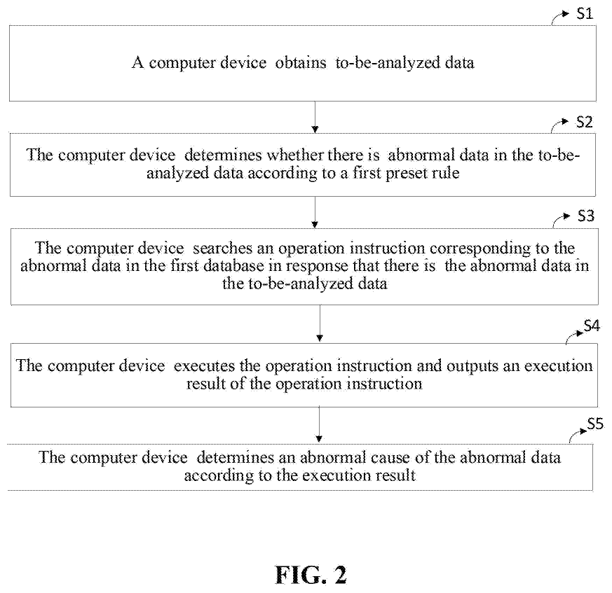

FIG. 2 is a flowchart of an embodiment of the data analysis method. Depending on the embodiment, additional blocks may be added, others removed, and the ordering of the blocks may be changed.

In block S1, the computer device 1 obtains to-be-analyzed data.

The to-be-analyzed data may be characters, numbers, or a combination of characters and numbers.

In an embodiment, the computer device 1 obtains the to-be-analyzed data by receiving the to-be-analyzed data sent by the terminal 2.

In another embodiment, the computer device 1 can obtain the to-be-analyzed data by retrieving data stored in other databases in a server or a cloud server. For example, the to-be-analyzed data can be retrieved from an Enterprise Resource Planning (ERP) system database in the cloud server, a financial database, and a personnel management database.

In another embodiment, the computer device 1 can obtain automatically the to-be-analyzed data from the server or the terminal 2 according to data collection conditions, a data collection period or data collection priorities.

In response that data is obtained, the computer device 1 also needs to determine the integrity of the obtained data, and determine whether the obtained data has associated data according to preset conditions. For example, the computer device 1 receives a data table A sent by the terminal 2, searches the data in the data table A, and determines whether the searched data is related to data in another data table. In response that the data in a related data table exists, the computer device 1 needs to obtain the data in the related data table.

In an embodiment, the data analysis method further includes: storing the to-be-analyzed data in a third database, which stores the to-be-analyzed data in a distributed storage manner. The third database is used to back up the to-be-analyzed data to ensure data integrity.

In block S2, the computer device 1 determines whether there is abnormal data in the to-be-analyzed data according to a first preset rule.

In an embodiment, after obtaining the to-be-analyzed data, the data analysis method further includes: performing a data cleaning processing on the to-be-analyzed data, the data cleaning processing includes adjusting a data format and/or deleting invalid data.

Adjustments of the data format include, but are not limited to, adjusting numbers of different code bases to a uniform base (e.g., decimal, hex, or octal), adjusting fonts of a to-be-processed text, and adjusting word order of the to-be-processed text. A method for deleting the invalid data includes, but is not limited to, deleting invalid spaces and deleting invalid symbols.

In an embodiment, the computer device 1 sends a prompt message to the terminal 2 in response that the to-be-analyzed data obtained by the computer device 1 from the same terminal 2 includes a preset number of data that does not meet requirements of the data format, or includes invalid characters that are greater than the preset number, for a plurality of times.

In an embodiment, after obtaining the to-be-analyzed data, and before determining whether there is abnormal data in the to-be-analyzed data according to the first preset rule, the data analysis method further includes: determining a type of the to-be-analyzed data, and searching the first preset rule corresponding to the type of the to-be-analyzed data in the first database.

The types of the to-be-analyzed data include, but are not limited to: a plurality of types are divided according to contents of the to-be-analyzed data, such as financial data, personnel data, and payment data; a plurality of types are divided according to the source of the data, such as incoming data for analyzing products according to different suppliers, data source according to different databases; a plurality of types are divided according to different data formats, such as text, numbers.

A plurality of first preset rules are stored in the first database. There are correspondences between the first preset rule and a type of the to-be-analyzed data. For example, when the data in the first database is divided into three types of data according to the contents of the data, namely the financial data, the personnel data, and the payment data. Accordingly, there are three first preset rules that correspond to the three types of data. For the first preset rule configured for the financial data, the financial data can be compared with financial data in a lookup table corresponding to the first preset rule, to determine whether the financial data conforms to the preset specification. For the first preset rule configured for the personnel data, the personnel data can be compared with personnel data in the lookup table corresponding to the first preset rule, to determine whether the personnel data conforms to the preset specification. For the first preset rule configured for the payment data, the payment data can be compared with payment data in the lookup table corresponding to the first preset rule, to determine whether the payment data conforms to the preset specification.

In block S3, the computer device 1 searches an operation instruction corresponding to the abnormal data in the first database in response that there is the abnormal data in the to-be-analyzed data.

In block S4, the computer device 1 executes the operation instruction and outputs an execution result of the operation instruction. The first database can store correspondences between abnormal data and operation instruction(s).

In an embodiment, the operation instruction includes: searching for information corresponding to a network address through a network connection, or searching for information in a specified check table.

For example, the to-be-analyzed data is an incoming price of a to-be-produced product, and after comparing the incoming price with information in the lookup table corresponding to the first preset rule, the incoming price is determined to be abnormal, then the operation instruction corresponding to the incoming price is retrieved and executed. The operation instruction includes: finding a current shipping price of the incoming manufacturer, changes of an exchange rate, tariffs and other factors to determine an abnormal cause of the incoming price.

For another example, the to-be-analyzed data is personnel information of a company, and after comparing the personnel information with information in the lookup table corresponding to the first preset rule, an employee's practice license is determined to be expired, then the operation instruction corresponding to the practice license is retrieved and executed. The operation instruction includes: determining whether to notify a target person about the validity period of the practice license, determining whether there is a relevant description of the target person about the practice license, determining whether there is alternative information of a job.

In block S5, the computer device 1 determines an abnormal cause of the abnormal data according to the execution result.

In an embodiment, the data analysis method further includes: determining whether the abnormal cause belongs to human factors; sending a prompt message in response that the abnormal cause belongs to the human factors; receiving an improvement plan; processing the abnormal data according to the improvement plan, and storing the processed abnormal data in a second database according to a second preset rule.

In an embodiment, the data analysis method further includes: generating a remark message in response that the abnormal cause does not belong to the human factors; adding the remark message to the abnormal data, and storing the added abnormal data in the second database according to the second preset rule.

For example, after comparing the incoming price with the information in the lookup table in the first preset rule, and an abnormal cause of the incoming price is that the recorded incoming price is inconsistent with the supplier's shipping price, and the abnormal cause is determined to belong to the human factors. A prompt message is sent to the terminal 2 of a corresponding staff member. After the abnormal data of the incoming price is processed, an improvement plan is sent to the computer device 1 through the terminal 2, the computer device 1 receives the improvement plan sent by the terminal 2, processes the abnormal data of the incoming price according to the improvement plan, and stores the abnormal data according to the second preset rule.

For example, after comparing the incoming price with the information in the lookup table corresponding to the first preset rule, and the abnormal cause of the incoming price is a difference in exchange rates, and the abnormal cause is determined to not belong to the human factors. A remark message is generated and added to the abnormal data in the incoming price, and the added abnormal data is stored in the second database according to the second preset rule.

In an embodiment, the data analysis method further includes: storing the to-be-analyzed data in the second database according to the second preset rule in response that there is no abnormal data in the to-be-analyzed data.

The data in the second database may be stored in a structured storage manner. An address corresponding to a type of the to-be-analyzed data is searched in the second database according to the type of the to-be-analyzed data, and the to-be-analyzed data is stored in an area corresponding to the address.

The second preset rule may be any one of a storage address of the to-be-analyzed data, a storage format of the to-be-analyzed data, and storage time of the to-be-analyzed data.

In an embodiment, it is determined whether there is abnormal data in the to-be-analyzed data according to a first preset rule, and an operation instruction corresponding to the abnormal data in a first database is executed in response that there is abnormal data in the to-be-analyzed data is found. An execution result of the operation instruction is outputted, and for different abnormal cause, the processed abnormal data is stored in the second database. Through the data analysis method, the data analysis is performed more intelligently, quickly and accurately, the efficiency of data analysis can be improved, and abnormal analyzed data can be classified to store.

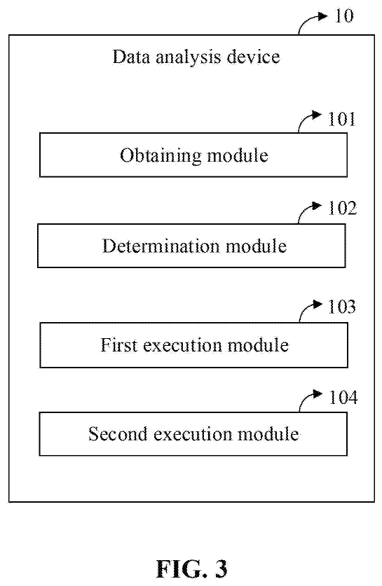

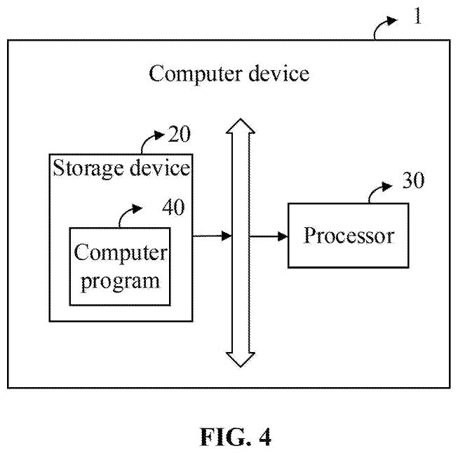

FIG. 2 shows the data analysis method of the present disclosure in detail. A data analysis device 10 and the computer device 1, which implement the data analysis method, are described below with respect to FIGS. 3-4.

It should be understood that the embodiments are for illustrative purposes only, and are not limited to the scope of the present disclosure.

FIG. 3 is a block diagram of an embodiment of a data analysis device.

In some embodiments, the data analysis device 10 may be run in a computer device. The data analysis device 10 may include a plurality of function modules including program code segments. Program codes of each program code segment in the data analysis device 10 may be stored in a storage device and executed by at least one processor to implement a data analysis function.

In an embodiment, the data analysis device 10 may be divided into a plurality of functional modules, according to the performed functions. The functional modules may include: an obtaining module 101, a determination module 102, a first execution module 103, and a second execution module 104. A module in the present disclosure refers to a series of computer-readable instruction segments that can be executed by the at least one processor and that are capable of performing fixed functions, which are stored in a storage device.

The obtaining module 101 is configured to obtain to-be-analyzed data.

The to-be-analyzed data may be characters, numbers, or a combination of characters and numbers.

In an embodiment, the obtaining module 101 can obtain the to-be-analyzed data by receiving the to-be-analyzed data sent by the terminal 2.

In another embodiment, the obtaining module 101 can obtain the to-be-analyzed data by retrieving data stored in other databases in a server or a cloud server. For example, the to-be-analyzed data can be retrieved from an Enterprise Resource Planning (ERP) system database in the cloud server, a financial database, and a personnel management database.

In another embodiment, the obtaining module 101 can obtain automatically the to-be-analyzed data from the server or the terminal 2 according to data collection conditions, a data collection period or data collection priorities.

In response to obtaining a data, the obtaining module 101 also needs to judge the integrity of the obtained data, and determine whether the obtained data has associated data according to preset conditions. For example, the obtaining module 101 receives a data table A sent by the terminal 2, searches the data in the data table A, and determines whether the searched data is related to data in another data table. In response that the data in a related data table exists, the obtaining module 101 needs to obtain the data in the related data table.

In an embodiment, the obtaining module 101 is further configured to store the to-be-analyzed data in a third database, which stores the to-be-analyzed data in a distributed storage manner. The third database is used to back up the to-be-analyzed data to ensure data integrity.

The determination module 102 is configured to determine whether there is an abnormal data in the to-be-analyzed data according to a first preset rule.

In an embodiment, the determination module 102 is further configured to perform data cleaning processing on the to-be-analyzed data after obtaining the to-be-analyzed data, the data cleaning processing includes adjusting a data format and/or deleting an invalid data.

Adjustments of the data format include, but are not limited to, adjusting numbers of different bases to a same base (e.g., decimal, hex, or octal), adjusting fonts of a to-be-processed text, and adjusting word order of the to-be-processed text. A method for deleting the invalid data includes, but is not limited to, deleting invalid spaces and deleting invalid symbols.

In an embodiment, the determination module 102 is further configured to send a prompt message to the terminal 2 in response that the to-be-analyzed data obtained by the computer device 1 from the same terminal 2 includes a preset number of data that does not meet requirements of the data format, or includes invalid characters that are greater than the preset number, for a plurality of times.

In an embodiment, the determination module 102 is further configured to determine a type of the to-be-analyzed data after obtaining the to-be-analyzed data, and before determining whether there is an abnormal data in the to-be-analyzed data according to the first preset rule, and search the first preset rule corresponding to the type of the to-be-analyzed data in the first database.

The types of the to-be-analyzed data include, but are not limited to: a plurality of types are divided according to contents of the to-be-analyzed data, such as financial data, personnel data, and payment data; a plurality of types are divided according to the source of the data, such as incoming data for analyzing products according to different suppliers, data source according to different databases; a plurality of types are divided according to different data formats, such as text, numbers.

A plurality of first preset rules are stored in the first database. There are correspondences between the first preset rule and a type of the to-be-analyzed data. For example, when the data in the first database is divided into three types of data according to the contents of the data, namely the financial data, the personnel data, and the payment data. Accordingly, there are three first preset rules that correspond to the three types of data. For the first preset rule configured for the financial data, the financial data can be compared with financial data in a lookup table corresponding to the first preset rule, to determine whether the financial data conforms to the preset specification. For the first preset rule configured for the personnel data, the personnel data can be compared with personnel data in the lookup table corresponding to the first preset rule, to determine whether the personnel data conforms to the preset specification. For the first preset rule configured for the payment data, the payment data can be compared with payment data in the lookup table corresponding to the first preset rule, to determine whether the payment data conforms to the preset specification.

The first execution module 103 is configured to search for an operation instructions corresponding to the abnormal data in the first database in response that there is the abnormal data in the to-be-analyzed data, execute the operation instruction, output an execution result of the operation instruction, and determine an abnormal cause of the abnormal data according to the execution result. The first database can store correspondences between abnormal data and operation instruction(s).

In an embodiment, the operation instruction includes: searching for information corresponding to a network address through a network connection, or searching for information in a specified check table.

For example, the to-be-analyzed data is an incoming price of a to-be-produced product, and after comparing the incoming price with information in the lookup table corresponding to the first preset rule, the incoming price is determined to be abnormal, then the operation instruction corresponding to the incoming price is retrieved and executed. The operation instruction includes: finding a current shipping price of the incoming manufacturer, changes of an exchange rate, tariffs and other factors to determine an abnormal cause of the incoming price.

For another example, the to-be-analyzed data is personnel information of a company, and after comparing the personnel information with information in the lookup table corresponding to the first preset rule, an employee's practice license is determined to be expired, then the operation instruction corresponding to the practice license is retrieved and executed. The operation instruction includes: determining whether to notify a target person about the validity period of the practice license, determining whether there is a relevant description of the target person about the practice license, determining whether there is alternative information of a job.

In an embodiment, the first execution module 103 is further configured to determine whether the abnormal cause belongs to human factors; send a prompt message in response that the abnormal cause belongs to the human factors; receive an improvement plan; processing the abnormal data according to the improvement plan, and store the processed abnormal data in a second database according to a second preset rule.

In an embodiment, the first execution module 103 is further configured to generate a remark message in response that the abnormal cause does not belong to the human factors; add the remark message to the abnormal data, and store the added abnormal data in the second database according to the second preset rule.

For example, after comparing the incoming price with the information in the lookup table in the first preset rule, and an abnormal cause of the incoming price is that the recorded incoming price is inconsistent with the supplier's shipping price, and the abnormal cause is determined to belong to the human factors is determined. A prompt message is sent to the terminal 2 of a corresponding staff member. After the abnormal data of the incoming price is processed, an improvement plan is sent to the first execution module 103 through the terminal 2, the first execution module 103 receives the improvement plan sent by the terminal 2, processes the abnormal data of the incoming price according to the improvement plan, and stores the abnormal data according to the second preset rule.

For example, after comparing the incoming price with the information in the lookup table corresponding to the first preset rule, and the abnormal cause of the incoming price is a difference in exchange rates, and the abnormal cause is determined to not belong to the human factors. A remark message is generated and added to the abnormal data in the incoming price, and the added abnormal data is stored in the second database according to the second preset rule.

The second execution module 104 is configured to store the to-be-analyzed data in the second database according to the second preset rule in response that there is not the abnormal data in the to-be-analyzed data.

The data in the second database may be stored in a structured storage manner. An address corresponding to a type of the to-be-analyzed data is searched in the second database according to the type of the to-be-analyzed data, and the to-be-analyzed data is stored in an area corresponding to the address.

The second preset rule may be any one of a storage address of the to-be-analyzed data, a storage format of the to-be-analyzed data, and a storage time of the to-be-analyzed data.

FIG. 4 is a block diagram of an embodiment of a computer device 1.

The computer device 1 may include a storage device 20, a processor 30, and a computer program 40, such as a data analysis program stored in the storage device 20 and executable by the processor 30. The processor 30 may execute the computer program 40 to implement the steps in the data analysis method described above, such as the blocks S1 to S5 in FIG. 2. Alternatively, the processor 30 may execute the computer program 40 to implement the functions of the data analysis device 10 described above, such as the modules 101 to 104 in FIG. 3.

In an exemplary embodiment, the computer program 40 may be divided into one or more modules/units, and the one or more modules/units are stored in the storage device 20 and executed by the processor 30 to complete the data analysis method of the present disclosure. The one or more modules/units can be a series of computer-readable instruction segments capable of performing specific functions, and the instruction segments are used to describe execution processes of the computer program 40 in the computer device 1. In one example, the computer program 40 may be divided into the obtaining module 101, the determination module 102, the first execution module 103, and the second execution module 104 in FIG. 3.

The computer device 1 may be a desktop computer, a notebook, a palmtop computer, or a cloud server. Those skilled in the art will understand that the block diagram is only an example of the computer device 1, and does not constitute a limitation on the computer device 1. Other examples of the computer device 1 may include more or fewer components than shown in FIG. 4, or combine some components or have different components. For example, the computer device 1 may further include an input/output device, a network access device, a bus, and the like.

The processor 30 may be a central processing unit (CPU) or another general-purpose processor, a digital signal processor (DSP), an application specific integrated circuit (ASIC), a Field-Programmable Gate Array (FPGA) or another programmable logic device, a discrete gate, or a transistor logic device, or a discrete hardware component, etc. The processor 30 may be a microprocessor or any conventional processor. The processor 30 may be a control center of the computer device 1 and connect various parts of the entire computer device 1 by using various interfaces and lines.

The storage device 20 may be configured to store the computer program 40 and/or modules/units. The processor 30 may run or execute the computer-readable instructions and/or modules/units stored in the storage device 20 and may invoke data stored in the storage device 20 to implement various functions of the computer device 1. The storage device 20 may include a program storage area and a data storage area. The program storage area may store an operating system, an application program required for at least one function (such as a sound playback function, an image playback function), etc. The data storage area may store data (such as audio data, or a phone book) created for using the computer device 1. In addition, the storage device 20 may include a random access memory, and may also include a non-transitory storage medium, such as a hard disk, an internal memory, a plug-in hard disk, a smart media card (SMC), and a secure digital (SD) card, a flash card, at least one disk storage device, a flash memory, or another non-transitory solid-state storage device.

When the modules/units integrated into the computer device 1 are implemented in the form of software functional units and used as independent units, they can be stored in a non-transitory readable storage medium. Based on this understanding, all or part of the processes in the methods of the above embodiments implemented by the present disclosure can also be completed by related hardware instructed by computer-readable instructions. The computer-readable instructions may be stored in a non-transitory readable storage medium. The computer-readable instructions, when executed by the processor, may implement the steps of the foregoing method embodiments. The computer-readable instructions include computer-readable instruction codes, and the computer-readable instruction codes can be source code, object code, an executable file, or in some intermediate form. The non-transitory readable storage medium may include any entity or device capable of carrying the computer-readable instruction code, a recording medium, a U disk, a mobile hard disk, a magnetic disk, an optical disk, a computer memory, and a read-only memory (ROM).

In several embodiments provided in the preset application, it should be understood that the disclosed computer device and method may be implemented in other ways. For example, the embodiment of the computer device described above is merely illustrative. For example, the units are only obtained by logical function divisions, and there may be other manners of division in actual implementation.

In addition, each functional unit in each embodiment of the present disclosure can be integrated into one processing unit, or can be physically present separately in each unit, or two or more units can be integrated into one unit. The above integrated unit can be implemented in a form of hardware or in a form of a software functional unit.

The present disclosure is not limited to the details of the above-described exemplary embodiments, and the present disclosure can be embodied in other specific forms without departing from the spirit or essential characteristics of the present disclosure. Therefore, the present embodiments are to be considered as illustrative and not restrictive, and the scope of the present disclosure is defined by the appended claims. All changes and variations in the meaning and scope of equivalent elements are included in the present disclosure. Any reference sign in the claims should not be construed as limiting the claim. Furthermore, the word “comprising” does not exclude other units nor does the singular exclude the plural. A plurality of units or devices stated in the system claims may also be implemented by one unit or device through software or hardware. Words such as “first” and “second” are used to indicate names but do not signify any particular order.

Finally, the above embodiments are only used to illustrate technical solutions of the present disclosure, and are not to be taken as restrictions on the technical solutions. Although the present disclosure has been described in detail with reference to the above embodiments, those skilled in the art should understand that the technical solutions described in one embodiment can be modified, or some of the technical features can be equivalently substituted and that these modifications or substitutions are not to detract from the essence of the technical solutions or from the scope of the technical solutions of the embodiments of the present disclosure.

What is claimed is:

1. A data analysis method, comprising:
obtaining to-be-analyzed data;
determining whether there is abnormal data in the to-be-analyzed data according to a first preset rule;
searching an operation instruction corresponding to the abnormal data in a first database in response that there is abnormal data in the to-be-analyzed data;
executing the operation instruction and outputting an execution result of the operation instruction, the first database storing correspondences between the abnormal data and the operation instruction;
determining an abnormal cause of the abnormal data according to the execution result.

2. The data analysis method of claim 1, further comprising:
storing the to-be-analyzed data in a second database according to a second preset rule in response that there is no abnormal data in the to-be-analyzed data.

3. The data analysis method of claim 1, further comprising:
determining whether the abnormal cause belongs to human factors;
sending a prompt message in response that the abnormal cause belongs to the human factors;
receiving an improvement plan;
processing the abnormal data according to the improvement plan;
storing the processed abnormal data in a second database according to a second preset rule.

4. The data analysis method of claim 3, further comprising:
generating a remark message in response that the abnormal cause does not belong to the human factors;
adding the remark message to the abnormal data;
storing the added abnormal data in the second database according to the second preset rule.

5. The data analysis method of claim 1, further comprising:
storing the to-be-analyzed data in a third database, wherein the third database stores the to-be-analyzed data in a distributed storage manner.

6. The data analysis method of claim 1, after obtaining the to-be-analyzed data, further comprising:
performing a data cleaning processing on the to-be-analyzed data, comprising: adjusting a data format and/or deleting invalid data;
wherein the determining whether there is abnormal data in the to-be-analyzed data according to the first preset rule comprises:
determining whether there is abnormal data in the to-be-analyzed data after performing the data cleaning processing, according to the first preset rule.

7. The data analysis method of claim 1, after obtaining the to-be-analyzed data, and before determining whether there is abnormal data in the to-be-analyzed data according to the first preset rule, further comprising:
determining a type of the to-be-analyzed data;
searching the first preset rule corresponding to the type of the to-be-analyzed data in the first database.

8. A computer device, comprising:
at least one processor; and
a storage device storing one or more programs which when executed by the at least one processor, causes the at least one processor to:
obtain to-be-analyzed data;
determine whether there is abnormal data in the to-be-analyzed data according to a first preset rule;
search an operation instruction corresponding to the abnormal data in a first database in response that there is abnormal data in the to-be-analyzed data;
execute the operation instruction and output an execution result of the operation instruction, the first database storing correspondences between the abnormal data and the operation instruction;
determine an abnormal cause of the abnormal data according to the execution result.

9. The computer device of claim 8, wherein the at least one processor further to:
store the to-be-analyzed data in a second database according to a second preset rule in response that there is no abnormal data in the to-be-analyzed data.

10. The computer device of claim 8, wherein the at least one processor further to:
determine whether the abnormal cause belongs to human factors;
send a prompt message in response that the abnormal cause belongs to the human factors;
receive an improvement plan;
process the abnormal data according to the improvement plan;
store the processed abnormal data in a second database according to a second preset rule.

11. The computer device of claim 10, wherein the at least one processor further to:
generate a remark message in response that the abnormal cause does not belong to the human factors;
add the remark message to the abnormal data;
store the added abnormal data in the second database according to the second preset rule.

12. The computer device of claim 8, wherein the at least one processor further to:
store the to-be-analyzed data in a third database, wherein the third database stores the to-be-analyzed data in a distributed storage manner.

13. The computer device of claim 8, after obtaining the to-be-analyzed data, wherein the at least one processor further to:
perform a data cleaning processing on the to-be-analyzed data, wherein the data cleaning comprises: adjusting a data format and/or deleting an invalid data;
wherein the at least one processor to determine whether there is abnormal data in the to-be-analyzed data according to the first preset rule comprises:
determine whether there is abnormal data in the to-be-analyzed data after performing the data cleaning processing, according to the first preset rule.

14. The computer device of claim 8, after obtaining the to-be-analyzed data, and before determining whether there is abnormal data in the to-be-analyzed data according to the first preset rule, wherein the at least one processor further to:
determine a type of the to-be-analyzed data;
search the first preset rule corresponding to the type of the to-be-analyzed data in the first database.

15. A non-transitory storage medium having stored thereon instructions that, when executed by a processor of a computer device, causes the computer device to perform a data analysis method, the method comprising:
obtaining to-be-analyzed data;
determining whether there is abnormal data in the to-be-analyzed data according to a first preset rule;
searching an operation instruction corresponding to the abnormal data in a first database in response that there is abnormal data in the to-be-analyzed data;
executing the operation instruction and outputting an execution result of the operation instruction, wherein the first database storing the correspondence between the abnormal data and the operation instruction;
determining an abnormal cause of the abnormal data according to the execution result.

16. The non-transitory storage medium of claim 15, the method further comprising:
storing the to-be-analyzed data in a second database according to a second preset rule in response that there is no abnormal data in the to-be-analyzed data.

17. The non-transitory storage medium of claim 15, the method further comprising:
determining whether the abnormal cause belongs to human factors;
sending a prompt message in response that the abnormal cause belongs to the human factors;
receiving an improvement plan;
processing the abnormal data according to the improvement plan;
storing the processed abnormal data in a second database according to a second preset rule.

18. The non-transitory storage medium of claim 17, the method further comprising:
generating a remark message in response that the abnormal cause does not belong to the human factors;
adding the remark message to the abnormal data;
storing the added abnormal data in the second database according to the second preset rule.

19. The non-transitory storage medium of claim 15, the method further comprising:
storing the to-be-analyzed data in a third database, wherein the third database stores the to-be-analyzed data in a distributed storage manner.

20. The non-transitory storage medium of claim 15, after obtaining the to-be-analyzed data, the method further comprising:
performing a data cleaning processing on the to-be-analyzed data, comprising: adjusting a data format and/or deleting invalid data;
wherein the determining whether there is an abnormal data in the to-be-analyzed data according to the first preset rule comprises:
determining whether there is abnormal data in the to-be-analyzed data after performing the data cleaning processing, according to the first preset rule.
